(19) United States
(12) Patent Application Publication
(10) Pub. No.: US 2009/0316042 A1
(43) Pub. Date: Dec. 24, 2009

(54) VIDEO PROCESSING METHODS AND RELATED DEVICES FOR DETERMINING TARGET MOTION VECTOR

(76) Inventors: Chin-Chuan Liang, Taichung City (TW); Te-Hao Chang, Taipei City (TW); Siou-Shen Lin, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/141,919

(22) Filed: Jun. 19, 2008

(51) Int. Cl. H04N 7/01; H04N 5/14

(52) U.S. Cl. 348/441; 348/699; 348/E07.003

(57) ABSTRACT

A video processing method for determining a target motion vector of a target image block includes: selecting a specific directional group from a plurality of directional groups by comparing penalty or likelihood of each direction specified by the directional groups, wherein the penalty of a direction is calculated by comparing candidate motion vector of the target image block with a motion vector of each neighboring image block in the corresponding directional group, and each of the directional groups is configured to include the target image block and at least a neighboring image block; and determining the target motion vector according to the candidate motion vector of the target image block and a motion vector of each neighboring image block in the specific directional group.

### BACKGROUND

The present invention relates to a video processing scheme, and more particularly, to a video processing method and related device for determining a target motion vector.

Generally speaking, for generating interpolated frames to comply with the frame rate of video display, it is necessary to compensate motion in original frames. Motion vectors are estimated by a motion estimator and fed to a motion compensated frame interpolator such as a motion judder canceller (MJC) for interpolated frame generation. In a case of neighboring blocks containing a boundary of objects moving in different direction or with different speed, the visual quality of the interpolated frame derived based on the motion vectors may be unsatisfied. The image quality of the interpolated frames can be improved by post-processing the motion vectors before providing to the motion compensated frame interpolator.

U.S. Pat. No. 5,699,499 discloses a motion vector post-processing scheme for preventing deterioration of the visual quality of interpolated pictures. The motion vector post-processing scheme utilizes a magnitude calculator and an order statistics filter to process the motion vectors. Specifically, magnitudes of motion vectors of a noted block and blocks adjacent thereto are obtained. The value of the motion vector of the noted block is substituted with a motion vector less than a magnitude at the center in the increasing order of magnitudes of the motion vectors.

### SUMMARY

One of the objectives of the present invention is to provide a video processing method and related device for determining a target motion vector to improve the visual quality of the interpolated frames especially at moving object boundaries.

According to an embodiment of the claimed invention, a video processing method for determining a target motion vector of a target image block is disclosed. The video processing method comprises steps of the following: selecting a specific directional group from a plurality of directional groups by comparing penalty or likelihood of directions specified by the directional groups, wherein the penalty or likelihood of a direction is calculated by comparing a candidate motion vector of the target image block with a motion vector of each neighboring image block in the corresponding directional group, and each of the directional groups is configured to include the target image block and at least a neighboring image block; and determining the target motion vector according to the candidate motion vector of the target image block and a motion vector of each neighboring image block in the specific directional group.

According to an embodiment of the claimed invention, a video processing device for determining a target motion vector of a target image block is further disclosed The video processing method comprises a selecting unit and a determining unit. The selecting unit is used for selecting a specific directional group from a plurality of directional groups by comparing penalty or likelihood of directions specified by the directional groups, wherein the penalty or likelihood of a direction is calculated by comparing a candidate motion vector of the target image block with a motion vector of each neighboring image block in the corresponding directional group, and each of the directional groups is configured to include the target image block and at least a neighboring image block. The determining unit is coupled to the selecting unit and used for determining the target motion vector according to the candidate motion vector of the target image block and a motion vector of each neighboring image block in the specific directional group.

According to an embodiment of the claimed invention, a video processing method for determining a target motion vector of a target image block, comprising steps of the following: selecting the target image block and at least a neighboring image block to form a specific directional group by comparing penalty or likelihood of a candidate motion vector of the target image block with a motion vector of neighboring image blocks; determining the target motion vector according to the candidate motion vector of the target image block and a motion vector of each neighboring image block in the specific directional group; and generating an interpolated frame based on the determined target motion vector.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing an example of 3*3 blocks in a frame.

FIG. 2 is a block diagram of a video processing device according to an embodiment of the present invention.

FIG. 3 is a diagram illustrating some examples of possible directional groups.

FIG. 4 is a diagram showing other possible directional groups.

FIG. 5 is a diagram illustrating two examples of selecting a 3*3 block of motion vector A₁ from a 5*5 block of motion vectors (A₂ and A₃).

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

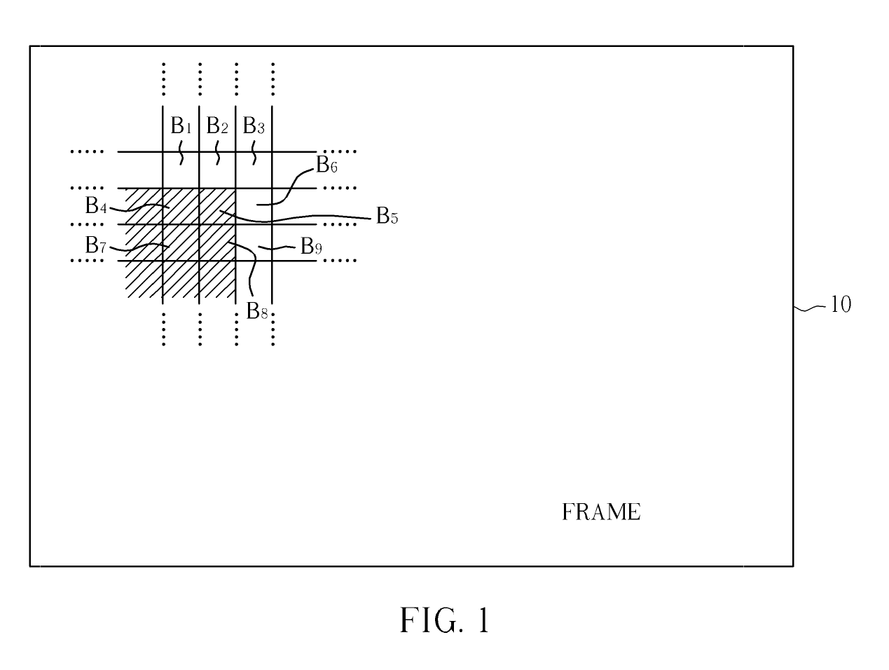

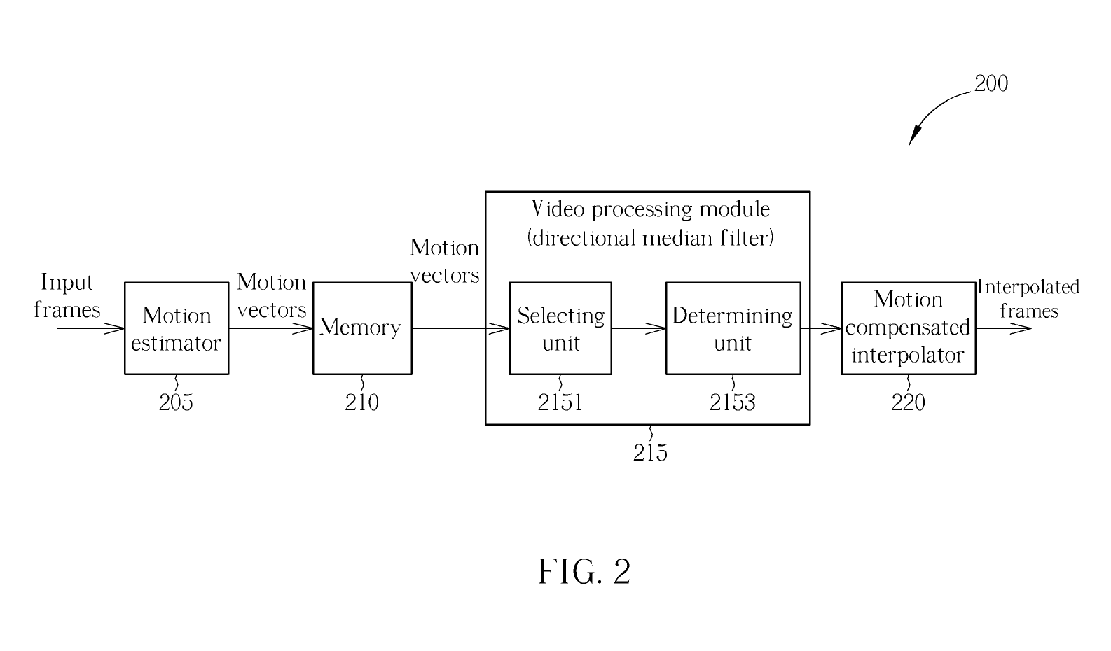

FIG. 1 is a video frame having a plurality of blocks, for example, B₁˜B₉. For ease of understanding the following descriptions, B₅ is a target image block, and blocks B₁˜B₄ and B₆-B₉ are neighboring image blocks. FIG. 2 is a block diagram of a video processing device 200 according to an embodiment of the present invention. The video processing device 200 comprises a motion estimator 205, a memory 210, a video processing module 215, and a motion compensated interpolator 220. In this embodiment, the video processing module 215 is a directional median filter and utilized for determining a target motion vector for the motion compensated interpolator 220. In this embodiment, the video processing module 215 includes a selecting unit 2151 and a determining unit 2153. The selecting unit 2151 is utilized for selecting a specific directional group from a plurality of directional groups by comparing a candidate motion vector of the target image block with a motion vector of each neighboring image block in each of the directional groups, where each of the directional groups is configured to include the target image block and at least a neighboring image block. The directional groups represent some possible shapes of object boundaries. The determining unit 2153 is used for determining a target motion vector according to the candidate motion vector and the motion vectors of neighboring image blocks in the specific directional group. That is, the spirit of this embodiment is to determine a preferred motion vector (i.e. the target motion vector) by considering possible object boundaries so as to improve the image quality of interpolated frames.

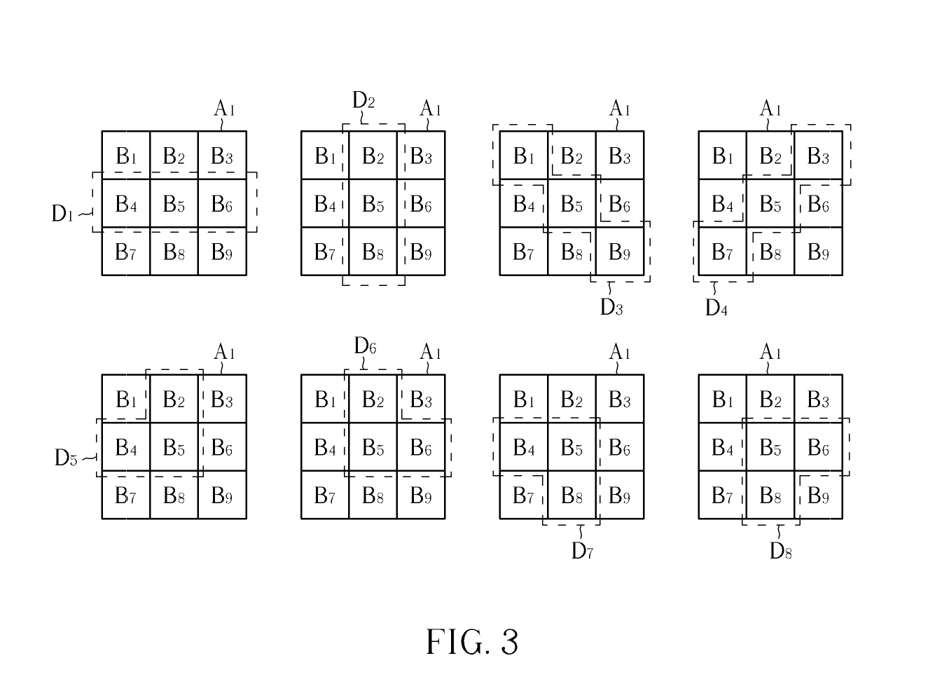

FIG. 3 is a diagram illustrating an example of possible directional groups D₁-D₈ in the above-mentioned embodiment. In this embodiment, an image block B₅ located at a center position of an image area A₁ is the target image block described above. The directional groups D₁-D₈ respectively correspond to different shapes of object boundaries; for example, the directional group D₂ may correspond to a long pillar, and one of the directional groups D₅-D₈ may correspond to a corner of a moving object. The shape of an actual object boundary may correspond to or be similar to that formed by image blocks included within one of the directional groups D₁-D₈. Therefore, when the selecting unit 2151 determines a directional group (i.e. the specific directional group) that is the closest to the shape of the actual object boundary, the target motion vector of the image block B₅ can be determined according to motion vectors of the image blocks included within the specific directional group. In determining the specific directional group from the directional groups D₁-D₈ in this embodiment, the selecting unit 2151 calculates a penalty of each direction. In an embodiment, the selecting unit 2151 calculates magnitude/angle differences between the candidate motion vector of the image block B₅ and the motion vector of each neighboring image block in each of the directional groups and then selects a minimum value in the magnitude/angle differences to determine the specific directional group corresponding to the minimum value. For instance, regarding the magnitude differences, the selecting unit 2151 sums up an absolute difference between the motion vectors of the image blocks B₅ and B₄ and an absolute difference between the motion vectors of the image blocks B₅ and B₆, for obtaining a summation S₁ corresponding to the directional group D₁. In similar ways, the selecting unit 2151 obtains summations S₂-S₈ corresponding to the directional groups D₂-D₈, respectively. Next, the selecting unit 2151 selects a minimum summation from the summations S₁-S₈ to determine the specific directional group corresponding to the minimum summation. The selecting unit 2151 selects the specific directional group corresponding to the minimum summation in this embodiment because the summations of the magnitude differences of the motion vectors are considered as penalties of various directions. This is further because a summation of absolute magnitude differences of the motion vectors of the image blocks in a directional group, which corresponds to or is most similar to the shape of the actual object boundary, should be very small. Additionally, calculating the angle differences to determine the specific directional group is similar to calculating the magnitude differences to determine the specific directional group; further description is not detailed for brevity.

In some other embodiments, the penalty of each direction is calculated by the following formula:

Sₙ=abs(MV_{A}.x−MV_{C}.x)+abs(MV_{A}.y−MV_{C}.y)+abs(MV_{B}.x−MV_{C}.x)+abs(MV_{B}.y−MV_{C}.y);

Where MV_{C} is the motion vector of the target image block, MV_{A} and MV_{B} are the motion vectors of two neighboring blocks, and x and y are horizontal and vertical components of the motion vector respectively.

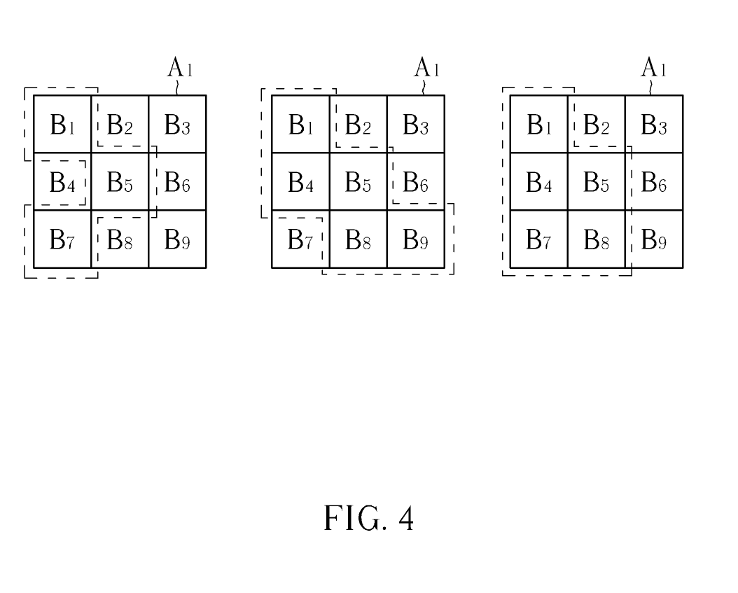

After the selecting unit 2151 selects the specific directional group, the determining unit 2153 determines the target motion vector of the target image block (e.g. B₅). A simple example for determining the target motion vector of the image block B₅ is to determine the target motion vector by a median value of motion vectors of image blocks in the specific directional group; in other words, the determining unit 2153 is considered as a median filter. An advantage of using the median value is to avoid selecting an erroneous or outlying motion vector in the specific directional group as the target motion vector of the image block B₅. For an example of the directional group D₁ as the specific directional group, if the candidate motion vector of the image block B₅ or one of the motion vectors of the image blocks B₃ and B₇ is substantially different from the others, a better image quality can still be ensured by taking a median value of the motion vectors of the image blocks in the directional group as the target motion vector of the image block B₅. Additionally, the determining unit 2153 can also determine the target motion vector as a result of the law of large numbers according to motion vectors of image blocks in the specific directional group. That is, the determining unit 2153 takes a motion vector that occupies a bigger part of the motion vectors of the image blocks in the specific directional group as the target motion vector. Furthermore, in another embodiment, the determining unit 2153 can generate the target motion vector by calculating a vector average of the motion vectors of the image blocks in the specific directional group. In other words, for the above-described example, instead of using the median value, the determining unit 2153 utilizes a vector average of the motion vectors in the specific directional group as the target motion vector; this also aids in obtaining a preferred target motion vector. Of course, using the above-mentioned directional groups is not intended to be a limitation of the present invention. Any modification regarding directional groups should fall within the scope of the present invention. For example, FIG. 4 shows three other examples of directional groups that might include three or more image blocks in each group. Another embodiment of the video processing device calculates a motion vector difference of the target image block and each neighboring image blocks in the 3*3 area, then two or more neighboring image blocks with the smallest motion vector differences are selected for deriving the target motion vector. The above embodiments describe calculating and comparing penalty of each direction and choose a direction with a least penalty, however, in some other embodiments, likelihood of each direction can be calculated and compared, and a direction with a highest likelihood is chosen. Some examples of calculating likelihood include computing similarity or correlation of motion vectors between the target image blocks and each neighboring image blocks.

In addition, the image area A₁ is not limited to being a 3*3 image area including the image blocks B₁-B₉; for example, in other embodiments, the image area A₁ can be a 4*4 image area including sixteen image blocks or any image areas having different numbers of image blocks.

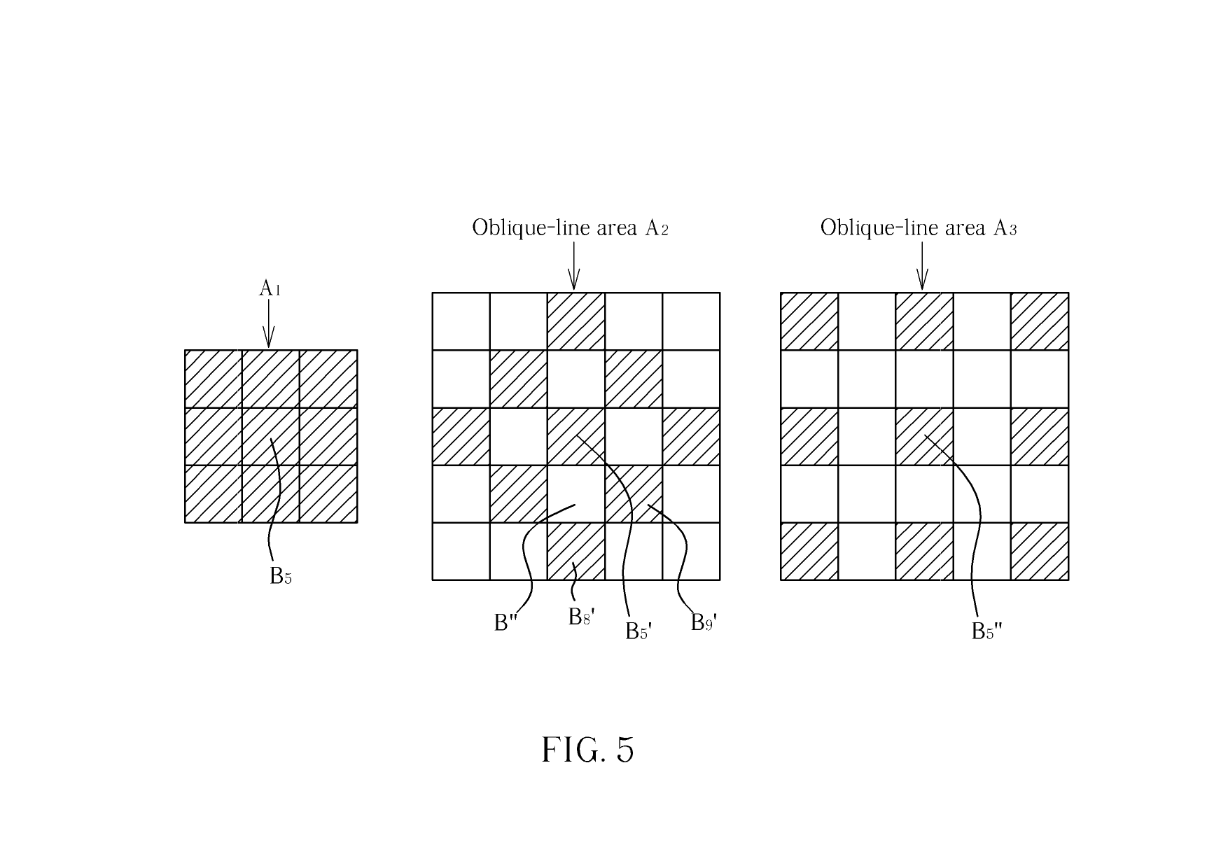

Additionally, in other embodiments, for each directional group, some neighboring image blocks are not immediately adjacent to the target image block. FIG. 5 is a diagram illustrating two different image areas A₂ and A₃ that are used to derive the image area A₁. Image blocks (oblique-line blocks) included in the image areas A₂ and A₃ are differently distributed over the range of a 5*5 square area, as shown in FIG. 5.

By using the image area A₂ or A₃, the image quality may be further improved since an image area distributed over a broader range can prevent the image quality from being influenced by erroneous motion vectors of some closely gathered image blocks. Similarly, generating a target motion vector by deriving a median or an average of the motion vectors selected in the image area A₂ or A₃ may improve image quality of interpolated frames. This also obeys the spirit of the present invention.

Those skilled in the art will readily observe that numerous modifications and alterations of the device and method may be made while retaining the teachings of the invention.

What is claimed is:

1. A video processing method for determining a target motion vector of a target image block, comprising:
selecting a specific directional group from a plurality of directional groups by comparing penalty or likelihood of directions specified by the directional groups, wherein the penalty or likelihood of a direction is calculated by comparing a candidate motion vector of the target image block with a motion vector of each neighboring image block in the corresponding directional group, and each of the directional groups is configured to include the target image block and at least a neighboring image block; and
determining the target motion vector according to the candidate motion vector of the target image block and a motion vector of each neighboring image block in the specific directional group.

2. The video processing method of claim 1, further comprising:
selecting an image block that is not immediately adjacent to the target image block as the neighboring image block in a directional group.

3. The video processing method of claim 1, wherein the step of selecting the specific directional group comprises:
calculating the penalty of a direction by calculating differences between the candidate motion vector of the target image block and the motion vector of each neighboring image block in the corresponding directional group; and
selecting a minimum difference to determine the specific directional group corresponding to the minimum difference.

4. The video processing method of claim 1, wherein the step of determining the target motion vector comprises:
determining the target motion vector by a result of law of large numbers according to motion vectors of image blocks in the specific directional group.

5. The video processing method of claim 1, wherein the step of determining the target motion vector comprises:
determining the target motion vector by a median value of motion vectors of image blocks in the specific directional group.

6. The video processing method of claim 1, wherein the step of determining the target motion vector comprises:
generating the target motion vector by calculating an average of motion vectors of image blocks in the specific directional group.

7. The video processing method of claim 1, further comprising:
generating an interpolated frame according to the target motion vector.

8. A video processing device for determining a target motion vector of a target image block, comprising:
a selecting unit, for selecting a specific directional group from a plurality of directional groups by comparing penalty or likelihood of directions specified by the directional groups, wherein the penalty or likelihood of a direction is calculated by comparing a candidate motion vector of the target image block with a motion vector of each neighboring image block in the corresponding directional group, and each of the directional groups is configured to include the target image block and at least a neighboring image block; and
a determining unit, coupled to the selecting unit, for determining the target motion vector according to the candidate motion vector of the target image block and a motion vector of each neighboring image block in the specific directional group.

9. The video processing device of claim 8, wherein the selecting unit selects an image block that is not immediately adjacent to the target image block as the neighboring image block in a directional group.

10. The video processing device of claim 8, wherein the selecting unit calculates the penalty of a direction by calculating differences between the candidate motion vector of the target image block and the motion vector of each neighboring image block in the corresponding directional group, and selects a minimum difference to determine the specific directional group corresponding to the minimum value.

11. The video processing device of claim 8, wherein the determining unit determines the target motion vector by a result of law of large numbers according to motion vectors of image blocks in the specific directional group.

12. The video processing device of claim 8, wherein the determining unit determines the target motion vector by a median value of motion vectors of image blocks in the specific directional group.

13. The video processing device of claim 8, wherein the determining unit generates the target motion vector by calculating a vector average of motion vectors of image blocks in the specific directional group.

14. The video processing device of claim 8, further comprising a motion compensated interpolator, receiving the target motion vector for generating an interpolated frame.

15. The video processing device of claim 8, further comprising a motion estimator, generating the candidate motion vectors of the target image block.

16. The video processing device of claim 15, further comprising a memory, storing the candidate motion vectors of the target image block and motion vectors of the neighboring image blocks for the selecting unit.

17. A video processing method for determining a target motion vector of a target image block, comprising:
selecting the target image block and at least a neighboring image block to form a specific directional group by comparing penalty or likelihood of a candidate motion vector of the target image block with a motion vector of neighboring image blocks;
determining the target motion vector according to the candidate motion vector of the target image block and a motion vector of each neighboring image block in the specific directional group; and
generating an interpolated frame based on the determined target motion vector.

18. The video processing method of claim 17, further comprising selecting an image block that is not immediately adjacent to the target image block as the neighboring image block.

19. The video processing method of claim 17, wherein the step of selecting the specific directional group comprises:
calculating the penalty by calculating differences between the candidate motion vector of the target image block and the motion vector of each neighboring image block; and
selecting the neighboring image block with a minimum difference to form the specific directional group.

20. The video processing method of claim 17, wherein the step of determining the target motion vector comprises:
determining the target motion vector by a median value of motion vectors of image blocks in the specific directional group.
